(19) United States
(12) Patent Application Publication
(10) Pub. No.: US 2022/0100795 A1
(43) Pub. Date: Mar. 31, 2022

(54) SYSTEMS AND METHODS FOR IMAGE RETRIEVAL

(71) Applicant: ZHEJIANG DAHUA TECHNOLOGY CO., LTD., Hangzhou (CN)

(72) Inventor: Shengguo CAO, Hangzhou (CN)

(73) Assignee: ZHEJIANG DAHUA TECHNOLOGY CO., LTD., Hangzhou (CN)

(21) Appl. No.: 17/643,585

(22) Filed: Dec. 9, 2021

Related U.S. Application Data
(63) Continuation of application No. PCT/CN2020/108966, filed on Aug. 13, 2020.

(30) Foreign Application Priority Data
Aug. 14, 2019 (CN) 201910748937.X

(51) Int. Cl. G06F 16/58

(52) U.S. Cl. CPC G06F 16/5866

(57) ABSTRACT

The present disclosure relates to systems and methods for image retrieval. The method may include obtaining an image retrieval request from a user device. The method may include identifying at least one target identification matching the image retrieval request from a plurality of candidate identifications in a database. Each of the plurality of candidate identifications may correspond to at least one candidate image and at least indicate position information associated with the at least one candidate image. The method may further include obtaining, based on the at least one target identification, at least one target image corresponding to the image retrieval request.

### CROSS-REFERENCE TO RELATED APPLICATIONS

This application is a Continuation of International Application No. PCT/CN2020/108966 filed on Aug. 13, 2020, which claims priority to Chinese Patent Application No. 201910748937.X filed on Aug. 14, 2019, the contents of which are incorporated herein by reference in their entirety.

### TECHNICAL FIELD

The present disclosure generally relates to image processing technology, and in particular, to systems and methods for image retrieval.

### BACKGROUND

With the rapid development of computer science, multimedia communication, network transmission, and image processing technologies, video monitoring technology develops rapidly nowadays. During video monitoring, a monitoring system generally captures images from video data according to predetermined rules (e.g., according to a predetermined time interval) for subsequent processing (e.g., retrieving needed images from the captured images). However, the predetermined rules may be limited, which may result in that the amount of the captured images is unnecessarily large. In addition, sometimes a monitoring device of the monitoring system may be under different motion states, which may result in that image qualities of the captured images may be relatively low, thereby influencing subsequent use. Therefore, it is desirable to provide systems and methods for image processing based on captured images which are captured in an improved manner, thereby improving image processing efficiency.

### SUMMARY

According to one aspect of the present disclosure, a method for image retrieval is provided. The method may be implemented on a computing device having one or more processors and one or more storage devices for storing data. The method may include obtaining an image retrieval request from a user device. The method may include identifying at least one target identification matching the image retrieval request from a plurality of candidate identifications in a database. Each of the plurality of candidate identifications may correspond to at least one candidate image and at least indicate position information associated with the at least one candidate image. The method may further include obtaining, based on the at least one target identification, at least one target image corresponding to the image retrieval request.

In some embodiments, the database may be established by a process. The process may include, for each of the plurality of candidate identifications, obtaining position information of an acquisition device; determining whether the position information satisfies a predetermined position condition; in response to a determination that the position information satisfies the predetermined position condition, capturing the at least one candidate image from at least one video stream corresponding to the position information based on a preset capture rule; and generating the candidate identification corresponding to the at least one candidate image based at least in part on the position information.

In some embodiments, the determining whether the position information satisfies the predetermined position condition may include determining whether a distance between a position of the acquisition device and a predetermined position is less than a distance threshold; or determining whether the position of the acquisition device is within a predetermined area.

In some embodiments, the preset capture rule may include at least one of a capture time interval, an image quality, or a count of the at least one candidate image.

In some embodiments, the capturing the at least one candidate image from the at least one video stream corresponding to the position information based on the preset capture rule may include obtaining state information of the acquisition device; and capturing, based on the state information and the preset capture rule, the at least one candidate image from the at least one video stream corresponding to the position information.

In some embodiments, the state information may include at least one of a motion speed of the acquisition device, time information associated with the acquisition device, or environment information associated with the acquisition device.

In some embodiments, the state information may include a motion speed of the acquisition device. In some embodiments, the capturing, based on the state information and the preset capture rule, the at least one candidate image from the at least one video stream corresponding to the position information may include determining whether the motion speed of the acquisition device is less than a first predetermined threshold; and in response to a determination that the motion speed is less than the first predetermined threshold, capturing, under a first capture mode, the at least one candidate image from at least one video stream corresponding to the position information based on the preset capture rule.

In some embodiments, in response to a determination that the motion speed is larger than or equal to the first predetermined threshold and less than a second predetermined threshold, the method may capture, under an intermediate capture mode, the at least one candidate image from the at least one video stream corresponding to the position information based on the preset capture rule.

In some embodiments, in response to a determination that the motion speed is larger than the second predetermined threshold, the method may capture, under a second capture mode, the at least one candidate image from the at least one video stream corresponding to the position information based on the preset capture rule.

In some embodiments, the database may be established by a process. The process may include, for each of the plurality of candidate identifications, obtaining position information of an acquisition device; determining whether the position information satisfies a predetermined position condition; in response to a determination that the position information satisfies the predetermined position condition, obtaining at least one tag corresponding to the at least one candidate image, the at least one tag at least indicating position information of the at least one candidate image in at least one video stream corresponding to the position information of the acquisition device; and generating the candidate identification corresponding to the at least one candidate image based at least in part on the at least one tag.

According to another aspect of the present disclosure, a method for image capturing is provided. The method may be implemented on a computing device having one or more processors and one or more storage devices for storing data. The method may include obtaining position information of an acquisition device. The method may include determining whether the position information satisfies a predetermined position condition. The method may also include, in response to a determination that the position information satisfies the predetermined position condition, capturing at least one candidate image from at least one video stream corresponding to the position information based on a preset capture rule. The method may further include generating an identification corresponding to the at least one candidate image based at least in part on the position information.

In another aspect of the present disclosure, a system for image retrieval is provided. The system may include at least one storage medium and at least one processor in communication with the at least one storage medium. The at least one storage medium may include a set of instructions. When executing the set of instructions, the at least one processor may be configured to cause the system to perform operations. The operations may include obtaining an image retrieval request from a user device. The operations may include identifying at least one target identification matching the image retrieval request from a plurality of candidate identifications in a database. Each of the plurality of candidate identifications may correspond to at least one candidate image and at least indicate position information associated with the at least one candidate image. The operations may further include obtaining, based on the at least one target identification, at least one target image corresponding to the image retrieval request.

In another aspect of the present disclosure, a system for image capturing is provided. The system may include at least one storage medium and at least one processor in communication with the at least one storage medium. The at least one storage medium may include a set of instructions. When executing the set of instructions, the at least one processor may be configured to cause the system to perform operations. The operations may include obtaining position information of an acquisition device. The operations may include determining whether the position information satisfies a predetermined position condition. The operations may also include, in response to a determination that the position information satisfies the predetermined position condition, capturing at least one candidate image from at least one video stream corresponding to the position information based on a preset capture rule. The operations may further include generating an identification corresponding to the at least one candidate image based at least in part on the position information.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary image retrieval system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating exemplary hardware and/or software components of an exemplary terminal device according to some embodiments of the present disclosure;

FIG. 4 is a block diagram illustrating an exemplary processing device according to some embodiments of the present disclosure;

FIG. 5 is a flowchart illustrating an exemplary process for image retrieval according to some embodiments of the present disclosure;

FIG. 6 is a schematic diagram illustrating an exemplary process for image retrieval according to some embodiments of the present disclosure;

FIG. 7 is a flowchart illustrating an exemplary process for establishing a database storing a plurality of candidate identifications according to some embodiments of the present disclosure;

FIG. 8 is a schematic diagram illustrating an exemplary correspondence relationship between a candidate identification and at least one candidate image according to some embodiments of the present disclosure;

FIG. 9 is a flowchart illustrating an exemplary process for capturing at least one candidate image from at least one video stream under different capture modes according to some embodiments of the present disclosure;

FIG. 10 is a schematic diagram illustrating exemplary capture modes according to some embodiments of the present disclosure;

FIG. 11 is a flowchart illustrating an exemplary process for establishing a database storing a plurality of candidate identifications according to some embodiments of the present disclosure;

FIG. 12 is a schematic diagram illustrating an exemplary correspondence relationship between a candidate identification and at least one tag according to some embodiments of the present disclosure;

FIG. 13 is a flowchart illustrating an exemplary process for image capturing according to some embodiments of the present disclosure;

FIG. 14 is a flowchart illustrating an exemplary process for image retrieval according to some embodiments of the present disclosure;

FIG. 15 is a flowchart illustrating an exemplary process for obtaining video data corresponding to target positions and capturing candidate images in the video data according to a preset capture rule according to some embodiments of the present disclosure; and

FIG. 16 is a flowchart illustrating an exemplary process for retrieving position information of candidate identifications based on spatial position information of an acquisition device and obtaining one or more candidate images corresponding to position information matching the spatial position information of the acquisition device according to some embodiments of the present disclosure.

### DETAILED DESCRIPTION

In the following detailed description, numerous specific details are set forth by way of examples in order to provide a thorough understanding of the relevant disclosure. However, it should be apparent to those skilled in the art that the present disclosure may be practiced without such details. In other instances, well-known methods, procedures, systems, components, and/or circuitry have been described at a relatively high-level, without detail, in order to avoid unnecessarily obscuring aspects of the present disclosure. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but to be accorded the widest scope consistent with the claims.

It will be understood that the terms “system,” “engine,” “unit,” “module,” and/or “block” used herein are one method to distinguish different components, elements, parts, sections, or assemblies of different levels in ascending order. However, the terms may be displaced by other expression if they may achieve the same purpose.

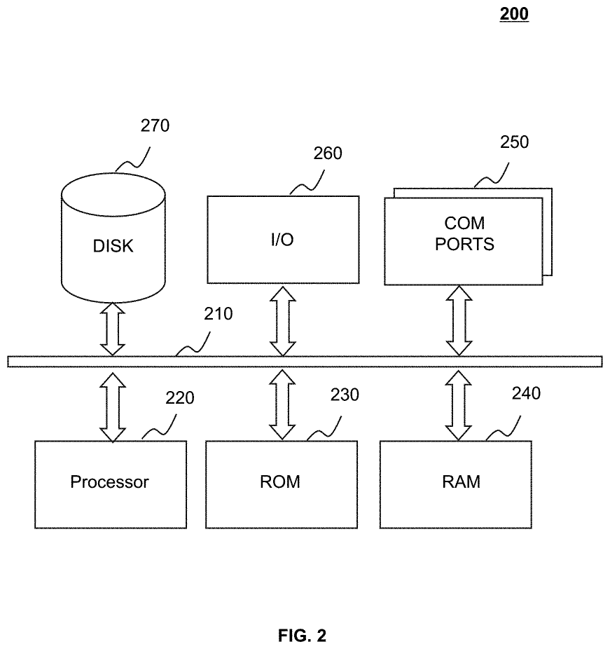

Generally, the words “module,” “unit,” or “block” used herein, refer to logic embodied in hardware or firmware, or to a collection of software instructions. A module, a unit, or a block described herein may be implemented as software and/or hardware and may be stored in any type of non-transitory computer-readable medium or other storage device. In some embodiments, a software module/unit/block may be compiled and linked into an executable program. It will be appreciated that software modules can be callable from other modules/units/blocks or from themselves, and/or may be invoked in response to detected events or interrupts. Software modules/units/blocks configured for execution on computing devices (e.g., processor 220 illustrated in FIG. 2) may be provided on a computer readable medium, such as a compact disc, a digital video disc, a flash drive, a magnetic disc, or any other tangible medium, or as a digital download (and can be originally stored in a compressed or installable format that needs installation, decompression, or decryption prior to execution). Such software code may be stored, partially or fully, on a storage device of the executing computing device, for execution by the computing device. Software instructions may be embedded in firmware, such as an EPROM. It will be further appreciated that hardware modules (or units or blocks) may be included in connected logic components, such as gates and flip-flops, and/or can be included in programmable units, such as programmable gate arrays or processors. The modules (or units or blocks) or computing device functionality described herein may be implemented as software modules (or units or blocks), but may be represented in hardware or firmware. In general, the modules (or units or blocks) described herein refer to logical modules (or units or blocks) that may be combined with other modules (or units or blocks) or divided into sub-modules (or sub-units or sub-blocks) despite their physical organization or storage.

It will be understood that when a unit, an engine, a module, or a block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The terminology used herein is for the purposes of describing particular examples and embodiments only and is not intended to be limiting. As used herein, the singular forms “a,” “an,” and “the” may be intended to include the plural forms as well, unless the context clearly indicates otherwise. It will be further understood that the terms “include” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

In addition, it should be understood that in the description of the present disclosure, the terms “first”, “second”, or the like, are only used for the purpose of differentiation, and cannot be interpreted as indicating or implying relative importance, nor can be understood as indicating or implying the order.

The flowcharts used in the present disclosure illustrate operations that systems implement according to some embodiments of the present disclosure. It is to be expressly understood, the operations of the flowcharts may be implemented not in order. Conversely, the operations may be implemented in an inverted order, or simultaneously. Moreover, one or more other operations may be added to the flowcharts. One or more operations may be removed from the flowcharts.

As aspect of the present disclosure relates to systems and methods for image retrieval. The systems may obtain an image retrieval request from a user device. The systems may also identify at least one target identification matching the image retrieval request from a plurality of candidate identifications in a database. Each of the plurality of candidate identifications may correspond to at least one candidate image and at least indicate position information associated with the at least one candidate image. Further, the systems may obtain, based on the at least one target identification, at least one target image corresponding to the image retrieval request. In the present disclosure, for each of the plurality of candidate identifications, the at least one candidate image is captured based on position information of an acquisition device (e.g., only when the position of the acquisition device is located in the vicinity of predetermined positions or within predetermined areas, candidate images are captured from corresponding video stream). Accordingly, the count of the captured candidate images may be effectively reduced and storage space can be saved. In addition, when the acquisition device is under different motion states, different motion modes may be used to capture the candidate images, which can improve image qualities of the candidate images. Further, candidate images in the database can be retrieved based on position information included in the image retrieval request, which can reduce retrieval time and improve retrieval efficiency.

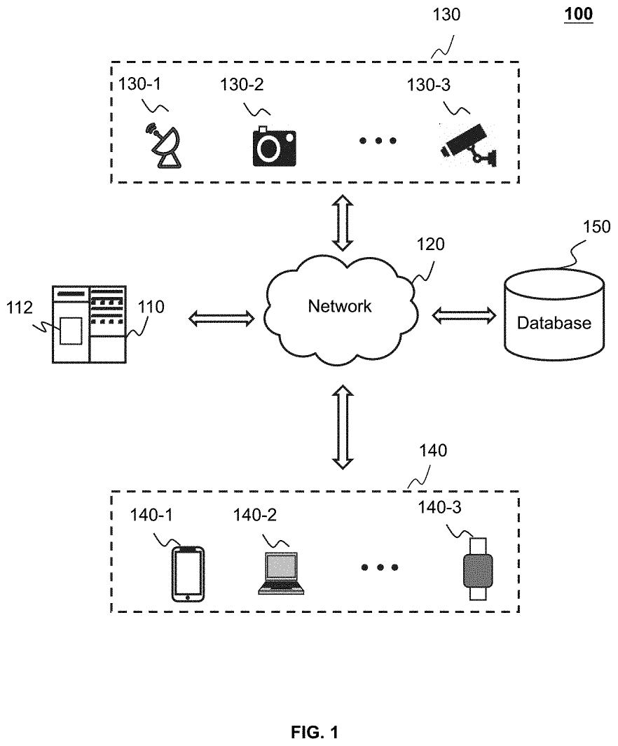

FIG. 1 is a schematic diagram illustrating an exemplary image retrieval system according to some embodiments of the present disclosure. As shown, the image retrieval system 100 may include a server 110, a network 120, an acquisition device 130, a user device 140, and a storage device 150.

The server 110 may be a single server or a server group. The server group may be centralized or distributed (e.g., the server 110 may be a distributed system). In some embodiments, the server 110 may be local or remote. For example, the server 110 may access information and/or data stored in the acquisition device 130, the user device 140, and/or the storage device 150 via the network 120. As another example, the server 110 may be directly connected to the acquisition device 130, the user device 140, and/or the storage device 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 including one or more components illustrated in FIG. 2 of the present disclosure.

In some embodiments, the server 110 may include a processing device 112. The processing device 112 may process information and/or data relating to image retrieval to perform one or more functions described in the present disclosure. For example, the processing device 112 may obtain an image retrieval request from a user device. The processing device 112 may identify at least one target identification matching the image retrieval request from a plurality of candidate identifications in a database. Each of the plurality of candidate identifications may correspond to at least one candidate image and at least indicate position information associated with the at least one candidate image. Further, the processing device 112 may obtain, based on the at least one target identification, at least one target image corresponding to the image retrieval request. In some embodiments, the processing device 112 may include one or more processing devices (e.g., single-core processing device(s) or multi-core processor(s)). Merely by way of example, the processing device 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

In some embodiment, the server 110 may be unnecessary and all or part of the functions of the server 110 may be implemented by other components (e.g., the acquisition device 130, the user device 140) of the image retrieval system 100. For example, the processing device 112 may be integrated into the acquisition device 130 or the user device 140 and the functions (e.g., obtaining the image retrieval request from the user device) of the processing device 112 may be implemented by the acquisition device 130 or the user device 140.

The network 120 may facilitate exchange of information and/or data for the image retrieval system 100. In some embodiments, one or more components (e.g., the server 110, the acquisition device 130, the user device 140, the storage device 150) of the image retrieval system 100 may transmit information and/or data to other component(s) of the image retrieval system 100 via the network 120. For example, the server 110 may obtain the image retrieval request from the user device 140 via the network 120. As another example, the server 110 may obtain the plurality of candidate identifications from the storage device 150. As a further example, the server 110 may transmit the target image to the user device 140 via the network 120. In some embodiments, the network 120 may be any type of wired or wireless network, or combination thereof. Merely by way of example, the network 120 may include a cable network (e.g., a coaxial cable network), a wireline network, an optical fiber network, a telecommunications network, an intranet, an Internet, a local area network (LAN), a wide area network (WAN), a wireless local area network (WLAN), a metropolitan area network (MAN), a public telephone switched network (PSTN), a Bluetooth network, a ZigBee network, a near field communication (NFC) network, or the like, or any combination thereof.

The acquisition device 130 may be configured to acquire an image (the “image” herein refers to a single image or a frame of a video). In some embodiments, the acquisition device 130 may include a camera 130-1, a video recorder 130-2, an image sensor 130-3, etc. The camera 130-1 may include a gun camera, a dome camera, an integrated camera, a monocular camera, a binocular camera, a multi-view camera, or the like, or any combination thereof. The camera 130-1 may also include a normal camera, a high-speed camera, a multi-mode camera (e.g., a camera configured with a high-speed camera mode and a normal camera mode), a PTZ (Pan-tilt/Zoom, pan-tilt omnidirectional (left/right/up/down) movement, lens zoom, zoom control) camera, or the like, or a combination thereof. The camera 130-1 may also include a visible light camera, an infrared imaging camera, a radar imaging camera, or the like, or any combination thereof.

The video recorder 130-2 may include a PC Digital Video Recorder (DVR), an embedded DVR, or the like, or any combination thereof. The image sensor 130-3 may include a Charge Coupled Device (CCD), a Complementary Metal Oxide Semiconductor (CMOS), or the like, or any combination thereof. In some embodiment, the acquisition device 130 may include any imaging device, such as a smartphone with a camera, a tablet computer, a video camera, a surveillance camera, or the like, or any combination thereof.

In some embodiments, the acquisition device 130 may be a fixed-position device (e.g., the surveillance camera). In some embodiments, the acquisition device 130 may be a device installed on an unmanned aerial vehicle, a transportation vehicle (e.g., a car, a motorcycle), etc. In some embodiments, the acquisition device 130 may be a device installed on a mobile device (e.g., a mobile phone, a tablet computer, a smart handheld terminal), a laptop computer, etc. In some embodiments, the acquisition device 130 may be an acquisition device installed on a wearable device (e.g., a smartwatch, a law enforcement instrument).

In some embodiments, the image acquired by the acquisition device 130 may be a two-dimensional image, a three-dimensional image, a four-dimensional image, etc. In some embodiments, the acquisition device 130 may include a plurality of components each of which can acquire an image or monitor other relevant information. For example, the acquisition device 130 may include a plurality of sub-cameras that can acquire images or videos simultaneously. As another example, the acquisition device 130 may be a combination of an infrared camera and a normal camera, which may monitor temperature information through infrared and acquire images of objects (e.g., pedestrians). In some embodiments, the acquisition device 130 may transmit the acquired image to one or more components (e.g., the server 110, the user device 140, the storage device 150) of the image retrieval system 100 via the network 120.

The user device 140 may be configured to receive information and/or data from the server 110, the acquisition device 130, and/or the storage device 150 via the network 120. For example, the user device 140 may receive a target image from the server 110. In some embodiments, the user device 140 may process information and/or data received from the server 110, the acquisition device 130, and/or the storage device 150 via the network 120. In some embodiments, the user device 140 may provide a user interface via which a user may view information and/or input data and/or instructions to the image retrieval system 100. For example, the user may view the target image via the user interface. As another example, the user may input an instruction associated with an image retrieval parameter via the user interface. In some embodiments, the user device 140 may include a mobile phone 140-1, a computer 140-2, a wearable device 140-3, or the like, or any combination thereof. In some embodiments, the user device 140 may include a display that can display information in a human-readable form, such as text, image, audio, video, graph, animation, or the like, or any combination thereof. The display of the user device 140 may include a cathode ray tube (CRT) display, a liquid crystal display (LCD), a light-emitting diode (LED) display, a plasma display panel (PDP), a three dimensional (3D) display, or the like, or a combination thereof. In some embodiments, the user device 140 may be connected to one or more components (e.g., the server 110, the acquisition device 130, the storage device 150) of the image retrieval system 100 via the network 120.

The storage device 150 may be configured to store data and/or instructions. The data and/or instructions may be obtained from, for example, the server 110, the acquisition device 130, the user device 140, and/or any other component of the image retrieval system 100. In some embodiments, the storage device 150 may store data and/or instructions that the server 110 may execute or use to perform exemplary methods described in the present disclosure. For example, the storage device 150 may store a plurality of candidate identifications, a plurality of candidate images associated with the plurality of candidate identifications, or the like, or any combination thereof. In some embodiments, the storage device 150 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (EPROM), an electrically erasable programmable ROM (EEPROM), a compact disk ROM (CD-ROM), and a digital versatile disk ROM, etc. In some embodiments, the storage device 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage device 150 may be connected to the network 120 to communicate with one or more components (e.g., the server 110, the acquisition device 130, the user device 140) of the image retrieval system 100. One or more components of the image retrieval system 100 may access the data or instructions stored in the storage device 150 via the network 120. In some embodiments, the storage device 150 may be directly connected to or communicate with one or more components (e.g., the server 110, the acquisition device 130, the user device 140) of the image retrieval system 100. In some embodiments, the storage device 150 may be part of other components of the image retrieval system 100, such as the server 110, the acquisition device 130, or the user device 140.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure.

FIG. 2 is a schematic diagram illustrating exemplary hardware and/or software components of an exemplary computing device according to some embodiments of the present disclosure. In some embodiments, the server 110 may be implemented on the computing device 200. For example, the processing device 112 may be implemented on the computing device 200 and configured to perform functions of the processing device 112 disclosed in this disclosure.

The computing device 200 may be used to implement any component of the image retrieval system 100 as described herein. For example, the processing device 112 may be implemented on the computing device 200, via its hardware, software program, firmware, or a combination thereof. Although only one such computer is shown, for convenience, the computer functions relating to image retrieval as described herein may be implemented in a distributed fashion on a number of similar platforms to distribute the processing load.

The computing device 200, for example, may include COM ports 250 connected to and from a network connected thereto to facilitate data communications. The computing device 200 may also include a processor (e.g., a processor 220), in the form of one or more processors (e.g., logic circuits), for executing program instructions. For example, the processor 220 may include interface circuits and processing circuits therein. The interface circuits may be configured to receive electronic signals from a bus 210, wherein the electronic signals encode structured data and/or instructions for the processing circuits to process. The processing circuits may conduct logic calculations, and then determine a conclusion, a result, and/or an instruction encoded as electronic signals. Then the interface circuits may send out the electronic signals from the processing circuits via the bus 210.

The computing device 200 may further include program storage and data storage of different forms including, for example, a disk 270, a read-only memory (ROM) 230, or a random-access memory (RAM) 240, for storing various data files to be processed and/or transmitted by the computing device 200. The computing device 200 may also include program instructions stored in the ROM 230, RAM 240, and/or another type of non-transitory storage medium to be executed by the processor 220. The methods and/or processes of the present disclosure may be implemented as the program instructions. The computing device 200 may also include an I/O component 260, supporting input/output between the computing device 200 and other components. The computing device 200 may also receive programming and data via network communications.

Merely for illustration, only one processor is illustrated in FIG. 2. Multiple processors 220 are also contemplated; thus, operations and/or method steps performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors 220 jointly or separately in the computing device 200 (e.g., a first processor executes step A and a second processor executes step B, or the first and second processors jointly execute steps A and B).

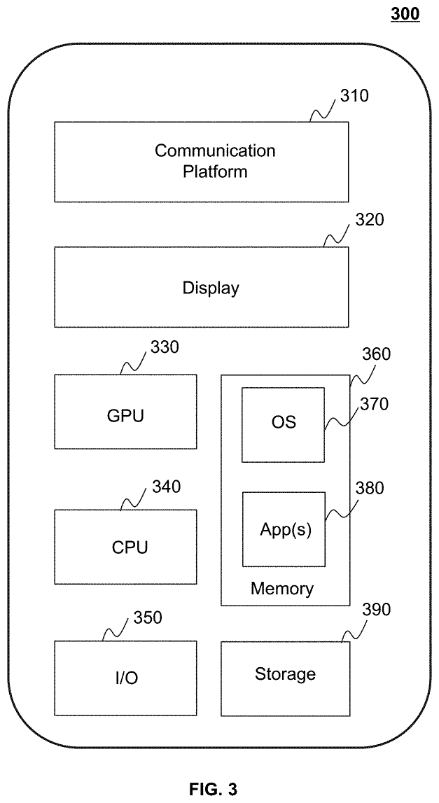

FIG. 3 is a schematic diagram illustrating exemplary hardware and/or software components of an exemplary terminal device according to some embodiments of the present disclosure. In some embodiments, the user device 140 may be implemented on the terminal device 300 shown in FIG. 3.

As illustrated in FIG. 3, the terminal device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the terminal device 300.

In some embodiments, an operating system 370 (e.g., iOS™, Android™′ Windows Phone™) and one or more applications (Apps) 380 may be loaded into the memory 360 from the storage 390 in order to be executed by the CPU 340. The applications 380 may include a browser or any other suitable mobile apps for receiving and rendering information relating to image retrieval or other information from the processing device 112. User interactions may be achieved via the I/O 350 and provided to the processing device 112 and/or other components of the image retrieval system 100 via the network 120.

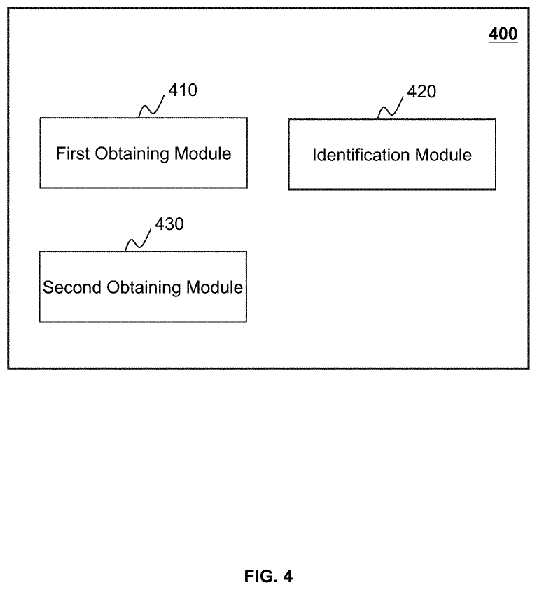

FIG. 4 is a block diagram illustrating an exemplary processing device according to some embodiments of the present disclosure. The processing device 112 may include a first obtaining module (also referred to as an “information obtaining module”) 410, an identification module (also referred to as a “retrieval module”) 420, and a second obtaining module 430.

The first obtaining module 410 may be configured to obtain an image retrieval request from a user device (e.g., the user device 140).

The identification module 420 may be configured to identify at least one target identification matching the image retrieval request from a plurality of candidate identifications in a database. In some embodiments, the identification module 420 may identify the at least one target identification from the plurality of candidate identifications based on matching degrees between the image retrieval request and the plurality of candidate identifications. In some embodiments, the identification module 420 may identify one or more candidate identifications with matching degrees with the image retrieval request satisfying a preset requirement as the at least one target identification. In some embodiments, the identification module 420 may identify the at least one target identification from the plurality of candidate identifications based on similarity degrees between the image retrieval request and the plurality of candidate identifications. In some embodiments, the identification module 420 may identify one or more candidate identifications with similarity degrees with the image retrieval request satisfying a preset requirement as the at least one target identification.

The second obtaining module 430 may be configured to obtain, based on the at least one target identification, at least one target image corresponding to the image retrieval request. In some embodiments, the second obtaining module 430 may obtain the at least one target image based on the at least one target identification from the database. Alternatively or additionally, the second obtaining module 430 may obtain the at least one target image based on the at least one target identification from the one or more video streams.

The modules in the processing device 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units.

For example, the processing device 112 may also include an establishment module (not shown) configured to establish the database. As another example, the processing device 112 may also include a transmission module (not shown) configured to transmit signals (e.g., electrical signals, electromagnetic signals) to one or more components (e.g., the acquisition device 130, the user device 140, the storage device 150) of the image coding system 100. As a further example, the processing device 112 may include a storage module (not shown) used to store information and/or data (e.g., the image retrieval request, the at least one target identification, the at least one target image) associated with the image retrieval. As a still further example, the second obtaining module 430 may be integrated into the identification module 420.

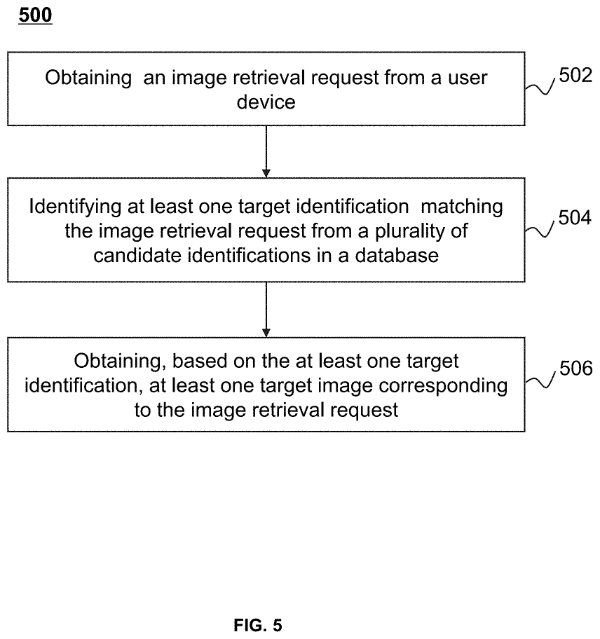

FIG. 5 is a flowchart illustrating an exemplary process for image retrieval according to some embodiments of the present disclosure. In some embodiments, the process 500 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 500. The operations of the illustrated process presented below are intended to be illustrative. In some embodiments, the process 500 may be accomplished with one or more additional operations not described and/or without one or more of the operations herein discussed. Additionally, the order in which the operations of the process as illustrated in FIG. 5 and described below is not intended to be limiting.

In 502, the processing device 112 (e.g., the first obtaining module 410) may obtain an image retrieval request from a user device (e.g., the user device 140).

In some embodiments, the image retrieval request may include retrieval information, for example, spatial position information (also can be referred to as “position information” for brevity) (e.g., a position (e.g., a preset point indicating a specified position), a position range), time information, object information (e.g., a vehicle, a traffic light, a pedestrian), quality information (e.g., an image resolution, a color depth, a contrast, an image noise), or the like, or a combination thereof.

In 504, the processing device 112 (e.g., the identification module 420) may identify at least one target identification matching the image retrieval request from a plurality of candidate identifications in a database. Each of the plurality of candidate identifications may correspond to at least one candidate image and at least indicate position information associated with the at least one candidate image.

As used herein, take a specific candidate identification as an example, the candidate identification refers to an identification (e.g., an ID, a spatial coordinate, a serial number, a code, a character string) indicating relevant information of at least one corresponding candidate image. In some embodiments, the relevant information may include the position information associated with the at least one candidate image (e.g., spatial position information of an acquisition device when the at least one candidate image is captured from a video stream acquired by the acquisition device), a capture time of the at least one candidate image, object information associated with the at least one candidate image, quality information of the at least one candidate image, an environmental condition when the at least one image is captured, or the like, or any combination thereof.

In some embodiments, also take the specific candidate identification as an example, the candidate identification may correspond to one candidate image or a plurality of candidate images. For example, the candidate identification may correspond to a plurality of candidate images captured from a plurality of video streams which are acquired according to different acquisition angles corresponding to same position information (e.g., a same position). As another example, the candidate identification may correspond to a plurality of candidate images captured at different time points corresponding to same position information (e.g., a same position).

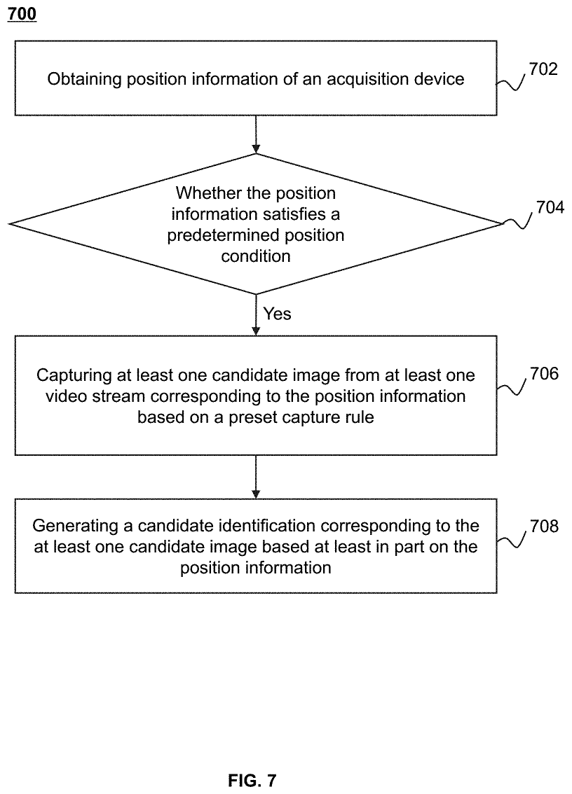

In some embodiments, also take the specific candidate identification as an example, the at least one candidate image may be stored in the database together with the candidate identification, wherein the candidate identification can be used as an index indicating the at least one candidate image. The index may be in a form of key-value, wherein the “key” is “candidate identification and the “value” is a specific access address of the at least one candidate image in the database. In some embodiments, the at least one candidate image may be stored in one or more video streams, wherein the candidate identification can be used as a pointer pointing to the at least one candidate image. More descriptions regarding the candidate identification and/or the at least one candidate image may be found elsewhere in the present disclosure (e.g., FIGS. 7, 8, 11, and 12 and the descriptions thereof).

In some embodiments, the processing device 112 may identify the at least one target identification from the plurality of candidate identifications based on matching degrees between the image retrieval request and the plurality of candidate identifications. In some embodiments, the processing device 112 may identify one or more candidate identifications with matching degrees with the image retrieval request satisfying a preset requirement as the at least one target identification.

For example, it is assumed that the retrieval information in the image retrieval request is “spatial position information,” for example, a position coordinate, if a candidate identification indicates spatial position information the same as or substantially the same as (e.g., a difference between which is less than a predetermined threshold) the position coordinate, it may be considered that the candidate identification satisfies the preset requirement. As another example, it is still assumed that the retrieval information in the image retrieval request is “spatial position information,” for example, a coordinate interval, if a candidate identification indicates spatial position information partially or completely located within the coordinate interval, it may be considered that the candidate identification satisfies the preset requirement.

In some embodiments, the processing device 112 may identify the at least one target identification from the plurality of candidate identifications based on similarity degrees between the image retrieval request and the plurality of candidate identifications. In some embodiments, the processing device 112 may identify one or more candidate identifications with similarity degrees with the image retrieval request satisfying a preset requirement (e.g., larger than a threshold (e.g., 98%, 95%, 90%, 85%, 80%) as the at least one target identification.

In 506, the processing device 112 (e.g., the second obtaining module 430) may obtain, based on the at least one target identification, at least one target image corresponding to the image retrieval request. As described above, each of the plurality of candidate identifications corresponds to at least one candidate image. Accordingly, each of the at least one target identification corresponds to at least one target image.

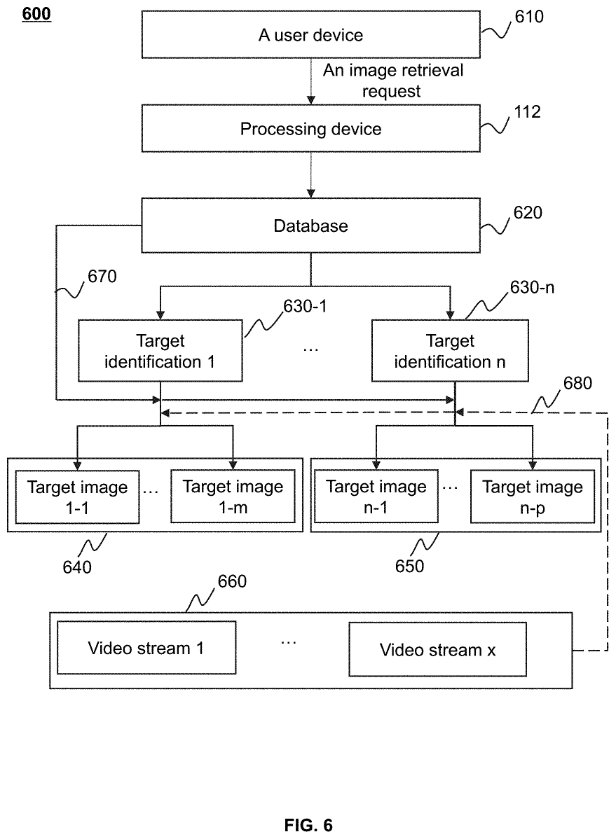

In some embodiments, the processing device 112 may obtain the at least one target image based on the at least one target identification from the database. Alternatively or additionally, the processing device 112 may obtain the at least one target image based on the at least one target identification from the one or more video streams. More descriptions regarding obtaining the at least one target image may be found elsewhere in the present disclosure (e.g., operations 670 and 680 in FIG. 6 and the descriptions thereof).

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, one or more other optional operations (e.g., a storing operation) may be added elsewhere in the process 500. In the storing operation, the processing device 112 may store information and/or data (e.g., the candidate identification, the candidate image) associated with the image retrieval in a storage device (e.g., the storage device 150) disclosed elsewhere in the present disclosure. As another example, the processing device 112 may obtain the image retrieval request from a component (e.g., an external device) other than the user device.

FIG. 6 is a schematic diagram illustrating an exemplary process for image retrieval according to some embodiments of the present disclosure.

As shown in FIG. 6, a user may initiate an image retrieval request via a user device 610, and the processing device 112 may receive the image retrieval request from the user device 610 via a data interface. Then the processing device 112 may identify at least one target identification (e.g., 630-1, . . . , and 630-n) from a plurality of candidate identifications in a database 620 according to the image retrieval request. As described in connection with FIG. 5, each of the plurality of candidate identifications corresponds to at least one candidate image. Accordingly, each of the at least one target identification corresponds to at least one target image. For example, the target identification 1 corresponds to a target image 1-1, . . . , and a target image 1-m; the target identification n corresponds a target image n−1, . . . , and a target image n−p.

In some embodiments, take a specific candidate identification as an example, the at least one candidate image may be stored in the database 620 together with the candidate identification, wherein the candidate identification can be used as an index indicating the at least one candidate image. Accordingly, the processing device 112 may obtain the at least one target image based on the at least one target identification from the database 620. For example, in 670, take a specific target identification as an example, the processing device 112 may directly retrieve the at least one target image from the database 620 using the target identification as an index.

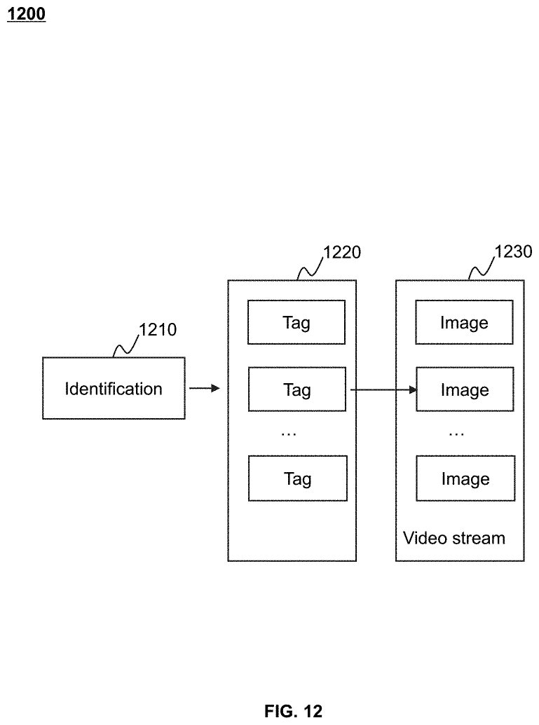

In some embodiments, the at least one candidate image may be stored in one or more video streams 660, wherein the candidate identification can be used as a pointer pointing to the at least one candidate image. Accordingly, the processing device 112 may obtain the at least one target image based on the at least one target identification from the one or more streams 660. For example, in 680, also take a specific target identification as an example, the processing device 112 may obtain the at least one target image from the one or more video streams 660 using the target identification as a pointer. More descriptions regarding the at least one candidate image and the one or more video streams may be found elsewhere in the present disclosure (e.g., FIG. 12 and the description thereof).

FIG. 7 is a flowchart illustrating an exemplary process for establishing a database storing a plurality of candidate identifications according to some embodiments of the present disclosure. In some embodiments, the process 700 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 700. The operations of the illustrated process presented below are intended to be illustrative. In some embodiments, the process 700 may be accomplished with one or more additional operations not described and/or without one or more of the operations herein discussed. Additionally, the order in which the operations of the process as illustrated in FIG. 7 and described below is not intended to be limiting.

In some embodiments, as described in connection with operation 504, the database may include a plurality of candidate identifications. During the process for establishing the database, the plurality of candidate identifications may be generated in a similar manner. For convenience, a specific candidate identification is described as an example in process 700.

In 702, the processing device 112 (e.g., the establishment module) may obtain position information of an acquisition device (e.g., the acquisition device 110).

In some embodiments, the processing device 112 may monitor the position information of the acquisition device in real time or according to a predetermined time interval. In some embodiments, the position information may be expressed in the form of latitude and longitude, angle coordinate, plane coordinate, or the like, or any combination thereof. In some embodiments, the position information may be a pan-tilt coordinate of the acquisition device. In some embodiments, the processing device 112 may obtain the position information of the acquisition device by retrieving a program interface, a data interface, a transmission interface, or the like, or a combination thereof.

In 704, the processing device 112 (e.g., the establishment module) may determine whether the position information satisfies a predetermined position condition.

In some embodiments, the predetermined position condition may be a distance threshold preset by the image retrieval system 100 or by a user. The distance threshold may be a constant, such as 1 centimeter, 5 centimeters, 10 centimeters, etc. Accordingly, the processing device 112 may determine whether the position information satisfies the predetermined position condition by determining whether a distance between a position of the acquisition device and a predetermined position is less than the distance threshold. In response to determining that the distance between the position of the acquisition device and the predetermined position is less than the distance threshold, the processing device 112 may determine that the position information of the acquisition device satisfies the predetermined position condition. In response to determining that the distance between the position of the acquisition device and the predetermined position is larger than or equal to the distance threshold, the processing device 112 may determine that the position information does not satisfy the predetermined position condition.

In some embodiments, the predetermined position condition may be a predetermined relative position relation preset by the image retrieval system 100 or by the user. For example, the predetermined relative position relation may be that the position of the acquisition device at least partially located within a predetermined area. Accordingly, the processing device 112 may determine whether the position information satisfies the predetermined position condition by determining whether the position of the acquisition device satisfies the predetermined relative position relation. For example, if the position of the acquisition device is completely within the predetermined area, the processing device 112 may determine that the position information satisfies the predetermined position condition. As another example, if at least a portion of the position of the acquisition device is within the predetermined area, the processing device 112 may determine that the position information of the acquisition device satisfies the predetermined position condition. As a further, it is assumed that the predetermined area is a three-dimensional area which corresponds to three coordinate ranges along three coordinate axes (i.e., X axis, Y axis, and Z axis) and the position of the acquisition device also corresponds to three coordinate points along the three coordinate axes, if at least one of the three coordinate points of the acquisition device is within the three coordinate ranges of the predetermined area, the processing device 112 may determine that the position information of the acquisition device satisfies the predetermined position condition.

In 706, in response to a determination that the position information satisfies the predetermined position condition, the processing device 112 (e.g., the establishment module) may capture at least one candidate image from at least one video stream corresponding to the position information based on a preset capture rule.

As used herein, the video stream refers to continuously acquired video data which includes a plurality of image frames. In some embodiments, the video stream may be continuously acquired by the acquisition device or another device that is connected to or communicates with the acquisition device. In some embodiments, the acquired video stream may be stored in a storage device (e.g., the storage device 150). Accordingly, the processing device 112 may access the video stream from the storage device. In some embodiments, the at least one video stream may be a plurality of video streams acquired at a current position (which satisfies the predetermined position condition) of the acquisition device according to different acquisition parameters (e.g., different acquisition angles, different field of views, different image resolutions).

In some embodiments, the preset capture rule may be set by the image retrieval system 100 or by a user. In some embodiments, the preset capture rule may include a capture time interval, an image quality, a count of the at least one candidate image, or the like, or any combination thereof.

The capture time interval refers to a time interval between which two adjacent candidate images are captured, which may be periodic or aperiodic. The image quality may include an image resolution, a color depth, a contrast, an image noise, or the like, or any combination thereof. Take a specific image frame in the at least one video stream, the processing device 112 may determine whether the image quality of the image frame satisfies a quality requirement. In response to determining that the image quality of the image frame satisfies the quality requirement, the processing device 112 may capture the image frame as a candidate image; otherwise, the processing device may ignore or skip the image frame. The count of the at least one candidate image may be a predetermined count set by the image retrieval system 100 or by a user, which may be related to monitoring requirements, environmental parameters, user preferences, etc. When the count of captured candidate images reaches the predetermined count, the processing device 112 may stop the capturing process.

In some embodiments, after capturing the at least one candidate image, the processing device 112 may perform a post-processing operation (e.g., a filtering operation) on the at least one candidate image. For example, the processing device 112 may select candidate image(s) with image quality satisfying a predetermined requirement as final candidate image(s). As another example, the processing device 112 may select candidate image(s) with image quality ranking top N as final candidate image(s). As a further example, the processing device 112 may select candidate image(s) corresponding to capture time interval greater than 2 frames as final candidate image(s).

In some embodiments, the processing device 112 may obtain state information of the acquisition device and capture the at least one candidate image from the at least one video stream corresponding to the position information based on the state information and the preset capture rule. In some embodiments, the state information may include a motion speed of the acquisition device, time information associated with the acquisition device, environment information associated with the acquisition device, etc.

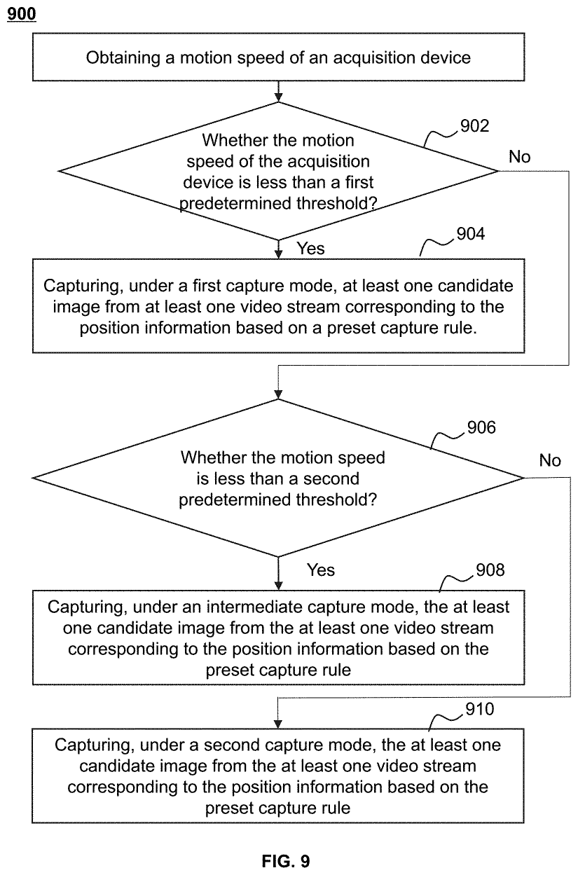

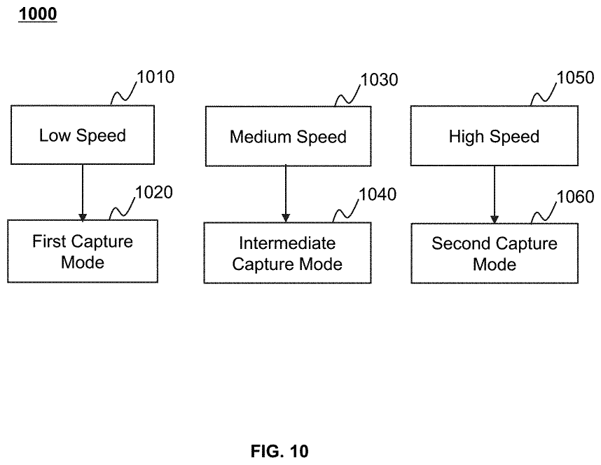

The motion speed of the acquisition device refers to a translational speed and/or a rotational speed of the acquisition device. In some embodiment, the processing device 112 may obtain the motion speed of the acquisition device from a sensor installed on the acquisition device. In some embodiments, the processing device 112 may capture the at least one candidate image based on different capture modes corresponding to different motion speeds. More descriptions regarding the capture modes may be found elsewhere in the present disclosure (e.g., FIG. 9, FIG. 10, and the descriptions thereof).

The time information associated with the acquisition device refers to a time point or a time period when the at least one video stream is acquired (or when the processing device 112 intends to capture at least one candidate image from the at least one video stream). In some embodiments, the processing device 112 may capture the at least one candidate image based on different capture parameters corresponding to different time points or time periods. For example, different time periods may correspond to different counts of candidate images to be captured.

The environmental information refers to any environmental parameter (e.g., a weather condition (e.g., “sunny,” “cloudy,” “rainy,” “snowy”), a light intensity, a haze level) of the environment where the acquisition device is located. In some embodiments, the processing device 112 may obtain the environmental information from a sensor installed on the acquisition device. In some embodiments, the processing device 112 may capture the at least one candidate image based on the environmental information. For example, if the weather condition is relatively fine (e.g., “sunny”) and the light intensity is relatively high, then the quality of the at least one video stream will be relatively good (e.g., a clarity and a contrast are relatively high), accordingly, the processing device 112 may capture the at least one candidate from the at least one video stream directly. As another example, if the weather condition is relatively bad (e.g., “cloudy,” “rainy”) and the light intensity is relatively weak, then the quality of the at least one video stream may be relatively low, that is, the at least one candidate image obtained from the at least one video stream may be relatively low, accordingly, the processing device 112 may post-process the at least one candidate image with the environmental information taken into consideration. Alternatively or additionally, the acquisition device or the device which is used to acquire the at least one video stream may automatically adjust acquisition parameters (e.g., open a flashlight) according to the environmental information so that the at least one video stream can meet quality requirements.

In some embodiments, after capturing the at least one candidate image, the processing device 112 may store the at least one candidate image in the database.

In 708, the processing device 112 (e.g., the establishment module) may generate a candidate identification corresponding to the at least one candidate image based at least in part on the position information.

As described above, since the at least one candidate image is obtained from the at least one video stream corresponding to the current position of the acquisition device, it can be considered that the at least one candidate image corresponds to the current position of the acquisition device. Accordingly, the processing device 112 may generate an identification (e.g., an ID, a spatial coordinate, a serial number, a code, a character string) indicating the position information of the at least one candidate image as the candidate identification.

In some embodiments, the processing device 112 may also integrate other information into the candidate identification, such as a capture time point of the at least one candidate image is captured, object information associated with the at least one candidate image, quality information of the at least one candidate image, an environmental condition when the at least one image is captured, or the like, or any combination thereof.

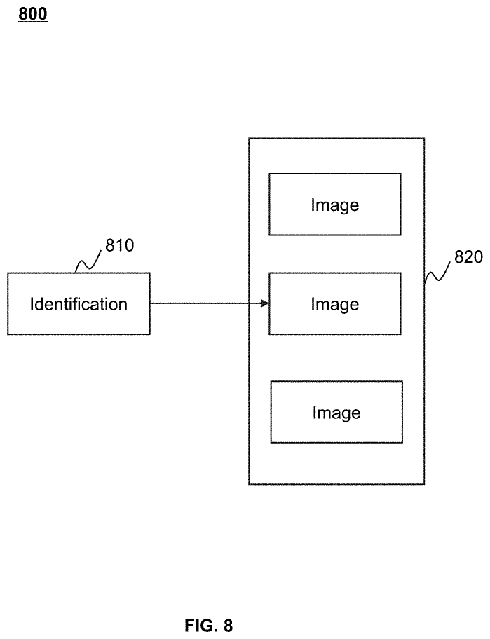

In some embodiments, after generating the candidate identification, the candidate identification may be stored in the database and used as an index indicating the at least one candidate image. In some embodiments, the processing device 112 may also generate a correspondence relationship (e.g., a table, a list) between the candidate identification and the at least one candidate image. More description regarding the correspondence relationship between the candidate identification and the at least one candidate image may be found elsewhere in the present disclosure (e.g., FIG. 8 and the description thereof).

In the present disclosure, the position information of the acquisition device is monitored, and only when the position information of the acquisition device satisfies the predetermined position condition, the candidate images are captured from corresponding video streams. Accordingly, compared with a manner in which the candidate images are captured according to a predetermined time interval, the count of the captured candidate images may be effectively reduced and storage space can be saved. Further, the position information of the acquisition device is expressed in the candidate identifications corresponding to the candidate images. Accordingly, a user can quickly retrieve target image(s) corresponding to a defined position, thereby improving the retrieval efficiency.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, when the position information of the acquisition device satisfies the predetermined position condition, the processing device 112 may direct the acquisition device (e.g., a capture unit of the acquisition device) to directly acquire at least one candidate image corresponding to the position information, instead of capturing from the video stream.

FIG. 8 is a schematic diagram illustrating an exemplary correspondence relationship between a candidate identification and at least one candidate image according to some embodiments of the present disclosure. As shown in FIG. 8, a candidate identification 810 and at least one candidate image 820 are stored in a database. The candidate identification 810 is used as an index indicating the at least one candidate image 820. Accordingly, the processing device 112 may perform an image retrieval based on the correspondence relationship between the candidate identification and the at least one candidate image.

FIG. 9 is a flowchart illustrating an exemplary process for capturing at least one candidate image from at least one video stream under different capture modes according to some embodiments of the present disclosure. In some embodiments, the process 900 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 900. The operations of the illustrated process presented below are intended to be illustrative. In some embodiments, the process 900 may be accomplished with one or more additional operations not described and/or without one or more of the operations herein discussed. Additionally, the order in which the operations of the process as illustrated in FIG. 9 and described below is not intended to be limiting.

In some embodiments, as described in connection with operation 706, the processing device 112 may capture at least one candidate image from at least one video stream based on a motion speed of the acquisition device and the preset rule.

In 901, the processing device 112 (e.g., the establishment module) may obtain the motion speed of an acquisition device. In some embodiments, the processing device 112 may obtain the motion speed of the acquisition device through a speed sensor or an operating parameter of the acquisition device.

In 902, the processing device 112 (e.g., the establishment module) may determine whether the motion speed of the acquisition device is less than a first predetermined threshold.

In some embodiments, the first predetermined threshold may be set by the image retrieval system 100 or by a user. In some embodiments, the first predetermined threshold may be a default setting of the image retrieval system 100 or may be adjustable under different situations. For example, the first predetermined threshold may be 5 cm/s, 10 cm/s, 100 cm/s, 0.1 rad/s, 1 rad/s, 2 rad/s, 3 rad/s, 5 rad/s, etc.

In 904, in response to a determination that the motion speed is less than the first predetermined threshold, the processing device 112 (e.g., the establishment module) may capture, under a first capture mode, the at least one candidate image from at least one video stream corresponding to the position information based on a preset capture rule. As used herein, the first capture mode can be considered as a “low-speed capture mode.”

In 906, in response to a determination that the motion speed is larger than or equal to the first predetermined threshold, the processing device 112 (e.g., the establishment module) may determine whether the motion speed of the acquisition device is less than a second predetermined threshold.

Similar to the first predetermined threshold, the second predetermined threshold may be set by the image retrieval system 100 or by a user. In some embodiments, the second predetermined threshold may be a default setting of the image retrieval system 100 or may be adjustable under different situations. For example, if the first predetermined threshold is 5 cm/s, the second predetermined threshold may be 10 cm/s, 15 cm/s, etc.

In 908, in response to a determination that the motion speed is less than the second predetermined threshold, the processing device 112 (e.g., the establishment module) may capture, under an intermediate capture mode, the at least one candidate image from the at least one video stream corresponding to the position information based on the preset capture rule. As used herein, the intermediate capture mode can be considered as a “medium-speed capture mode.”

In 910, in response to a determination that the motion speed is larger than or equal to the second predetermined threshold, the processing device 112 (e.g., the establishment module) may capture, under a second capture mode, the at least one candidate image from the at least one video stream corresponding to the position information based on the preset capture rule. As used herein, the second capture mode can be considered as a “high-speed capture mode.”

More description regarding the first capture mode, the intermediate capture mode, and the second capture mode may be found elsewhere in the present disclosure (e.g., FIG. 10 and the description thereof).

In the present disclosure, an appropriate image capture mode can be selected based on the motion speed of the acquisition device, which can improve capture quality.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure. For example, when the motion speed of the acquisition device is greater than the second predetermined threshold (i.e., the acquisition device is under high-speed), the processing device 112 may capture a plurality of intermediate-candidate images from the at least one video stream and determine the at least one candidate image by post-processing (e.g., performing an image reconstruction) the plurality of intermediate-candidate images.

FIG. 10 is a schematic diagram illustrating exemplary capture modes according to some embodiments of the present disclosure.

As shown in FIG. 10, different motion speeds may correspond to different capture modes, for example, a low speed (e.g., less than the first predetermined threshold) 1010 may correspond to a first capture mode 1020, a medium speed (e.g., larger than or equal to the first predetermined threshold and less than the second predetermined threshold) 1030 may correspond to an intermediate capture mode 1040, and a high speed (e.g., larger than or equal to the second predetermined threshold) 1050 may correspond to a second capture mode 1060.

In some embodiments, different capture modes may correspond to different capture parameters (e.g., a capture time interval, a count of the at least one candidate image). For example, for the first capture mode 1020 corresponding to the low-speed, the capture time interval may be relatively long and/or the count of the at least one candidate image may be relatively small. As another example, for the intermediate capture mode 1040 corresponding to the medium speed, the capture time interval may be medium and/or the count of the at least one candidate image may be accordingly medium. As a further example, for the second capture mode 1060 corresponding to the high speed, the capture time interval may be relatively short and/or the count of the at least one candidate image may be relatively large.

In some embodiments, different motion speeds may correspond to different acquisition parameters of the video streams from which the candidate images are captured. In some embodiments, the acquisition parameters may be determined based on a machine learning model.

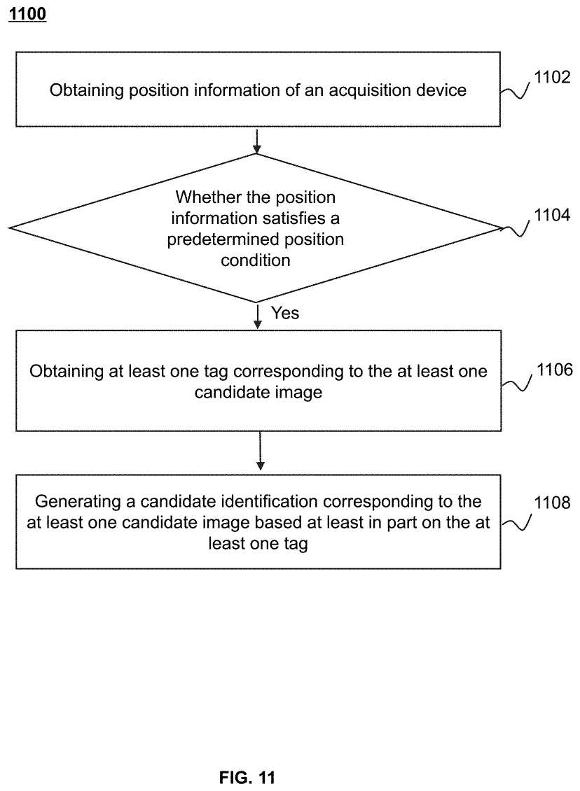

FIG. 11 is a flowchart illustrating an exemplary process for establishing a database storing a plurality of candidate identifications according to some embodiments of the present disclosure. In some embodiments, the process 1100 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 1100. The operations of the illustrated process presented below are intended to be illustrative. In some embodiments, the process 1100 may be accomplished with one or more additional operations not described and/or without one or more of the operations herein discussed. Additionally, the order in which the operations of the process as illustrated in FIG. 11 and described below is not intended to be limiting.

In some embodiments, as described in connection with operation 504, the database may include a plurality of candidate identifications. During the process for establishing the database, the plurality of candidate identifications may be generated in a similar manner. For convenience, a specific candidate identification is described as an example in process 1100.

In 1102, the processing device 112 (e.g., the establishment module) may obtain the position information of an acquisition device. As described in connection with FIG. 7, operation 1102 may be performed in a similar manner as operation 702.

In 1104, the processing device 112 (e.g., the establishment module) may determine whether the position information satisfies the predetermined position condition. As described in connection with FIG. 7, operation 1104 may be performed in a similar manner as operation 704.

In 1106, in response to a determination that the position information satisfies the predetermined position condition, the processing device 112 (e.g., the establishment module) may obtain at least one tag corresponding to the at least one candidate image. The at least one tag may at least indicate position information of the at least one candidate image in at least one video stream corresponding to the position information of the acquisition device. As used herein, the tag may be any expression (e.g., a serial number, a value, a code) which can indicate position information of a corresponding candidate image in a video stream. More descriptions regarding the video stream may be found elsewhere in the present disclosure (e.g., FIG. 7 and the description thereof).

In 1108, the processing device 112 (e.g., the establishment module) may generate a candidate identification corresponding to the at least one candidate image based at least in part on the at least one tag.

In some embodiments, the processing device 112 may combine the at least one tag as the candidate identification corresponding to the at least one candidate image. Accordingly, the candidate identification can indicate the position information of the at least one candidate image.

In some embodiments, similar to operation 708, the processing device 112 may also integrate other information into the candidate identification, such as a time point when the at least one candidate image is acquired during the acquisition process of the at least one video stream, object information associated with the at least one candidate image, quality information of the at least one candidate image, an environmental condition when the at least one image is captured, or the like, or any combination thereof.

In some embodiments, after generating the candidate identification, the candidate identification may be stored in the database and used as a pointer pointing to the at least one candidate image (or the at least one tag corresponding to the at least one candidate image). In some embodiments, the processing device 112 may also generate a correspondence relationship (e.g., a table, a list) between the candidate identification and the at least one tag. More description regarding the correspondence relationship between the candidate identification and the at least one tag may be found elsewhere in the present disclosure (e.g., FIG. 12 and the description thereof).

In the present disclosure, the position information of the acquisition device is monitored and when the position information of the acquisition device satisfies the predetermined position condition, the tags corresponding to candidate images and indicating position information of the candidate images in corresponding video streams are obtained. Then a correspondence relationship between candidate identifications and tags is established and used for image retrieval. That is, the candidate images are actually stored in the video streams rather than the database, which can save storage space and improve retrieval efficiency.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

FIG. 12 is a schematic diagram illustrating an exemplary correspondence relationship between a candidate identification and at least one tag according to some embodiments of the present disclosure. As shown in FIG. 12, a candidate identification 1210 points to at least one tag 1220 which corresponds to at least one candidate image 1230 in a video stream. The candidate identification 1210 is used as a pointer pointing to the at least one candidate image 1230 (or the at least one tag 1220 corresponding to the at least one candidate image 1230). Accordingly, the processing device 112 may perform an image retrieval based on the correspondence relationship between the candidate identification and the at least one tag.

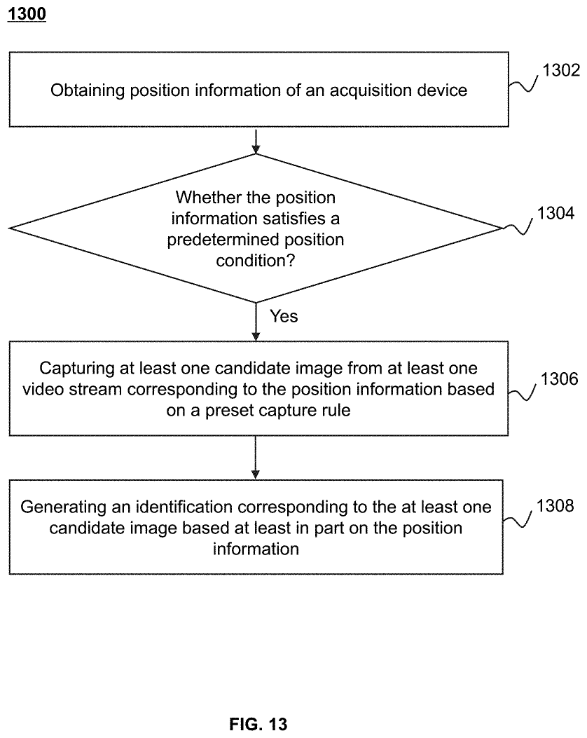

FIG. 13 is a flowchart illustrating an exemplary process for image capturing according to some embodiments of the present disclosure. In some embodiments, the process 1300 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 1300. The operations of the illustrated process presented below are intended to be illustrative. In some embodiments, the process 1300 may be accomplished with one or more additional operations not described and/or without one or more of the operations herein discussed. Additionally, the order in which the operations of the process as illustrated in FIG. 13 and described below is not intended to be limiting.

In 1302, the processing device 112 may obtain position information of an acquisition device. As described in connection with FIG. 7, operation 1302 may be performed in a similar manner as operation 702.

In 1304, the processing device 112 may determine whether the position information satisfies a predetermined position condition. As described in connection with FIG. 7, operation 1304 may be performed in a similar manner as operation 704.

In 1306, in response to a determination that the position information satisfies the predetermined position condition, the processing device 112 may capture at least one candidate image from at least one video stream corresponding to the position information based on a preset capture rule. As described in connection with FIG. 7, operation 1306 may be performed in a similar manner as operation 706.

In 1308, the processing device 112 may generate an identification corresponding to the at least one candidate image based at least in part on the position information. As described in connection with FIG. 7, operation 1308 may be performed in a similar manner as operation 708.

In some embodiments, the processing device 112 may monitor the position information of the acquisition device and capture at least one candidate image corresponding to each of a plurality of positions satisfying the predetermined position condition. Further, the processing device 112 may establish a database storing a plurality of candidate identifications and/or corresponding candidate images and used for image retrieval.

It should be noted that the above description is merely provided for the purposes of illustration, and not intended to limit the scope of the present disclosure. For persons having ordinary skills in the art, multiple variations or modifications may be made under the teachings of the present disclosure. However, those variations and modifications do not depart from the scope of the present disclosure.

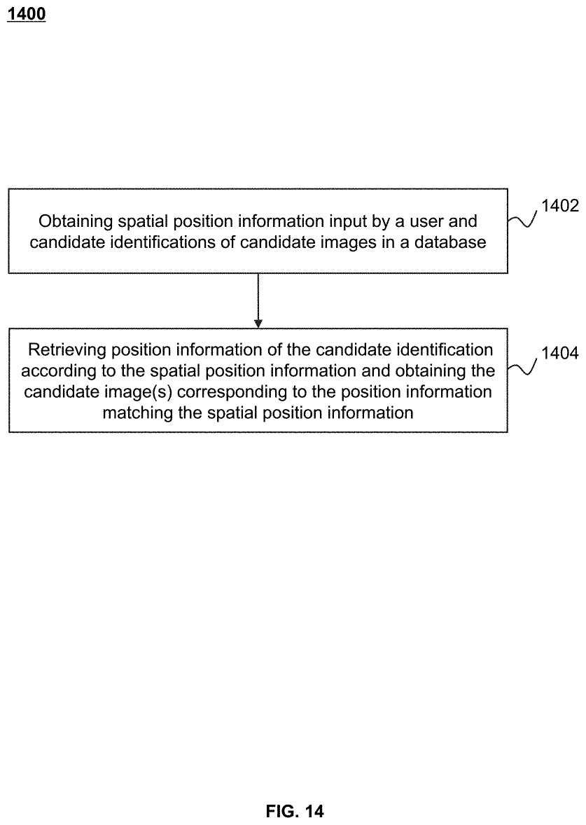

FIG. 14 is a flowchart illustrating an exemplary process for image retrieval according to some embodiments of the present disclosure. In some embodiments, the process 1400 may be implemented as a set of instructions (e.g., an application) stored in the storage ROM 230 or RAM 240. The processor 220 and/or the modules in FIG. 4 may execute the set of instructions, and when executing the instructions, the processor 220 and/or the modules may be configured to perform the process 1400. The operations of the illustrated process presented below are intended to be illustrative. In some embodiments, the process 1400 may be accomplished with one or more additional operations not described and/or without one or more of the operations herein discussed. Additionally, the order in which the operations of the process as illustrated in FIG. 5 and described below is not intended to be limiting.

In 1402, the processing device 112 (e.g., the obtaining module 410) may obtain spatial position information (e.g., a pan-tilt coordinate) input by a user and candidate identifications of candidate images in a database (e.g., an image library). As used herein, the spatial position information may include a horizontal angle and/or a vertical angle of rotation of an acquisition device (e.g., a camera), and the candidate identification may include a position coordinate.

Specifically, the user may input the spatial position information that the user intends to retrieve through a computer device to obtain the candidate identification of the candidate images in the database.

In some embodiments, before the operation 1402, the processing device 112 may obtain a plurality of target positions input by a user, obtain video data corresponding to the target positions, and capture candidate images in the video data according to a preset capture rule. Then the processing device 112 may obtain position information of the candidate images and generate candidate identifications corresponding to the candidate images. Further, the processing device 112 may store the candidate images and the corresponding candidate identifications in a database. In some embodiments, the video data may be a video stream acquired in real time. Specifically, the processing device 112 may obtain the target positions input by the user, which may be specific pan-tilt coordinates of the acquisition device. The processing device 112 may obtain video data corresponding to the target positions and capture candidate images in the video data according to a capture time interval and/or an image resolution. The processing device 112 may also obtain spatial position information of the acquisition device when the candidate images are captured and time information when the candidate images are captured. Further, the processing device 112 may generate the candidate identifications according to the position information of the candidate images and store the candidate images and the corresponding candidate identifications in the database. In some embodiments, the candidate identification may include an image type, a capture time, and the position information (e.g., a position coordinate).

In some embodiments, the processing device 112 may obtain current spatial position information of the acquisition device. If the current spatial position information is consistent with a target position, the processing device 112 may obtain video data corresponding to the current position information and capture one or more candidate images in the video data according to the preset capture rule. If the current spatial position information is inconsistent with the target position, the processing device 112 may continue to monitor the spatial position information of the acquisition device. Further, if the spatial position information is consistent with the target position, the processing device 112 may obtain a motion state of the acquisition device. If the motion state is a static state, the processing device 112 may the video data corresponding to the current position information and capture the one or more candidate images in the video data according to the preset capture rule. If the motion state is not the static state, the processing device 112 may continue to monitor the motion state.

In some embodiments, the processing device 112 may obtain a preset point and obtain the spatial position information based on a correspondence relationship between preset points and spatial position information. The user may pre-name specific position information as preset points. For example, a position A may be set as a preset point which indicates the spatial position information. The preset point may correspond to a specific name and the user may only need to input the name of the preset point to retrieve the corresponding candidate image(s), thereby optimizing the user experience. The spatial position information corresponding to the preset point may be either a coordinate point or a coordinate interval. In the embodiment, the spatial position information corresponding to the preset point may be the coordinate point.

In 1404, the processing device 112 (e.g., the identification module 420) may retrieve position information of the candidate identifications based on the spatial position information of the acquisition device and obtain the candidate image(s) corresponding to position information matching the spatial position information of the acquisition device.

Specifically, the spatial position information input by the user may be the coordinate point or the coordinate interval. If the spatial position information is a coordinate point, the processing device 112 may obtain candidate image(s) corresponding to a coordinate point the same as the spatial position information. If the spatial position information is a coordinate interval, the processing device 112 may obtain the candidate images corresponding to all coordinate points within the coordinate interval. Then the user may retrieve needed images from the candidate images according to specific requirements. Furthermore, if there are a plurality of candidate images, the plurality of candidate images may be presented in a list in a chronological order, which is convenient for the user to view the images.

In some embodiments, the target position may be expressed as (P₀, T₀), position information in index data may be expressed as (P₁, T₁), and a preset distance value may be set as S. The preset distance value may be a preset matching distance. The preset distance value S may be input by the user, for example, S=1°. If a distance between two points is less than or equal to S, it may be considered that the two points match with each other. If the distance between the two points is larger than S, it may be considered that the two points do not match with each other. An exemplary determination equation may be expressed as (P₁−P₀)²+(T₁−T₀)²≤S².

In some embodiments, if no position information corresponding to the spatial position information of the acquisition device is identified in the candidate identifications, the processing device 112 may prompt that there is no corresponding candidate image and end the retrieval process.

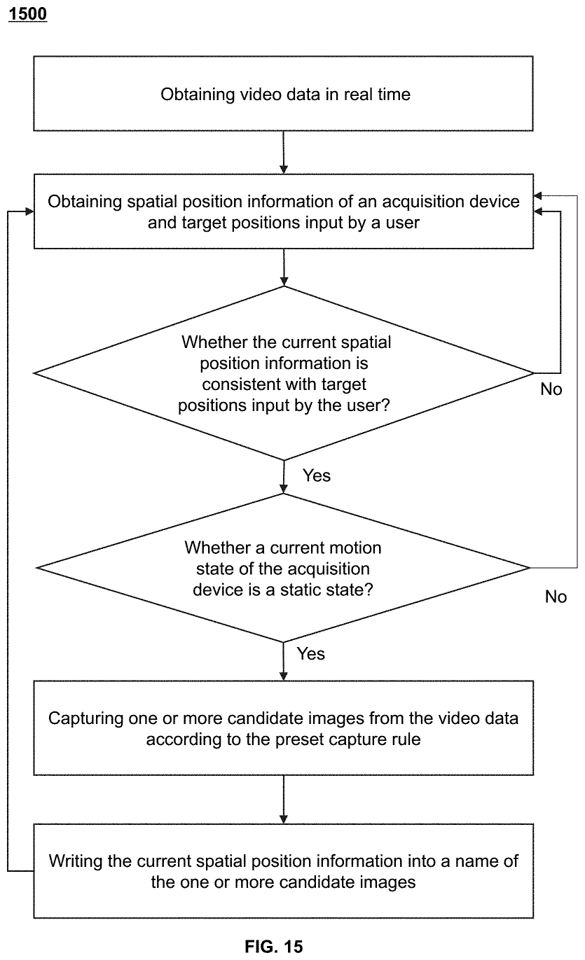

In some embodiments, as shown in FIG. 15, an exemplary process for obtaining the video data corresponding to the target positions and capturing candidate images in the video data according to the preset capture rule is provided.

The acquisition device may obtain the video data in real time. The processing device 112 may obtain the current spatial position information of the acquisition device and the target positions input by the user. The processing device 112 may capture candidate images based on the current spatial position information and the target positions input by the user. The processing device 112 may determine whether the current spatial position information is consistent with the target positions input by the user. If the current spatial position information is inconsistent with the target positions input by the user, the current spatial position information is re-acquired. If the current spatial position information is consistent with one of the target positions input by the user, the processing device 112 may determine whether a current motion state of the acquisition device is a static state. If the current motion state of the acquisition device is a moving state, the current spatial position information may be re-obtained (i.e., the current spatial position information of the acquisition device is monitored). If the current motion state of the acquisition device is the static state, the processing device 112 may capture one or more candidate images from the video data according to the preset capture rule and write the current spatial position information into the name of the one or more candidate images. The preset capture rule may include a preset capture time interval, an image resolution, etc. In some embodiments, the processing device 112 may also write the capture time(s) of the one or more candidate images into the name of the one or more candidate images. In some embodiments, type(s) of the one or more candidate images may be marked as a position image(s).

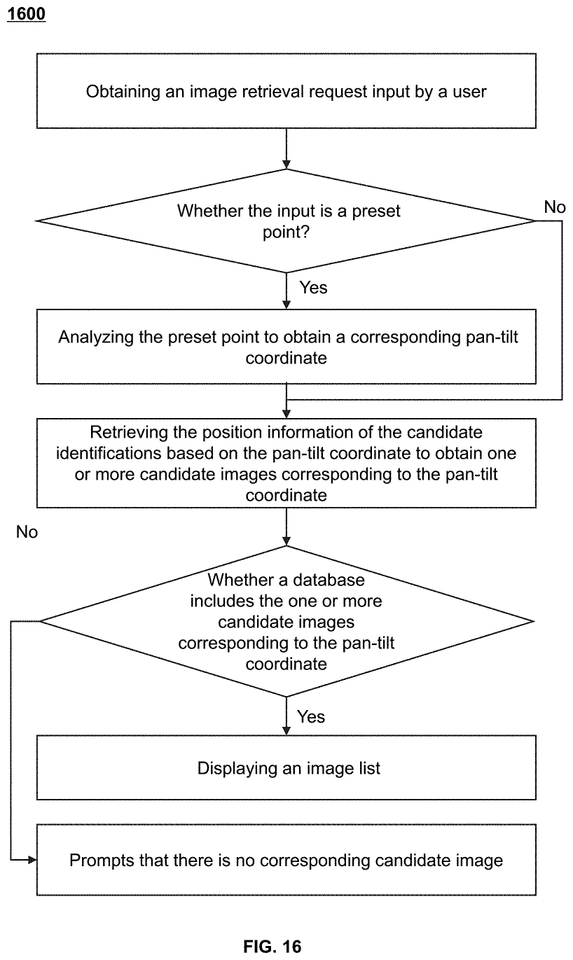

In some embodiments, as shown in FIG. 16, an exemplary process for retrieving position information of candidate identifications based on the spatial position information of the acquisition device and obtaining one or more candidate images corresponding to position information matching the spatial position information of the acquisition device is provided.

The processing device 112 may obtain an image retrieval request input by a user. The image retrieval request may include the spatial position information of the acquisition device, for example, a pan-tilt coordinate or a preset point. If the user inputs the preset point, the processing device 112 may analyze the preset point to obtain a corresponding pan-tilt coordinate and retrieve the position information of the candidate identifications based on the pan-tilt coordinate to obtain the one or more candidate images corresponding to the pan-tilt coordinate. If the user inputs the pan-tilt coordinate, the analysis operation may be omitted. The processing device 112 may directly retrieve the position information of the candidate identifications based on the pan-tilt coordinate to obtain the one or more candidate images corresponding to the pan-tilt coordinate. If the database includes the one or more candidate images corresponding to the pan-tilt coordinate, a candidate image list may be displayed. If no position information corresponding to the pan-tilt coordinate is identified in the candidate identifications, the processing device 112 may prompt that there is no corresponding candidate image and end the retrieval process.

According to the above process, by obtaining the image retrieval request input by the user and the candidate identification of all candidate images in the database, the processing device may retrieve the position information in the candidate identification according to the pan-tilt coordinate, and obtain the candidate image corresponding to the pan-tilt coordinate, thereby quickly positioning the candidate image corresponding to the pan-tilt coordinate.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or comlocation of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer-readable program code embodied thereon.

A computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in a combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A method for image retrieval, comprising:
obtaining an image retrieval request from a user device;
identifying at least one target identification matching the image retrieval request from a plurality of candidate identifications in a database, each of the plurality of candidate identifications corresponding to at least one candidate image and at least indicating position information associated with the at least one candidate image; and
obtaining, based on the at least one target identification, at least one target image corresponding to the image retrieval request.

2. The method of claim 1, wherein the database is established by a process including:
for each of the plurality of candidate identifications,
obtaining position information of an acquisition device;
determining whether the position information satisfies a predetermined position condition;
in response to a determination that the position information satisfies the predetermined position condition, capturing the at least one candidate image from at least one video stream corresponding to the position information based on a preset capture rule; and
generating the candidate identification corresponding to the at least one candidate image based at least in part on the position information.

3. The method of claim 2, wherein the determining whether the position information satisfies the predetermined position condition includes:
determining whether a distance between a position of the acquisition device and a predetermined position is less than a distance threshold; or
determining whether the position of the acquisition device is within a predetermined area.

4. The method of claim 2, wherein the preset capture rule includes at least one of a capture time interval, an image quality, or a count of the at least one candidate image.

5. The method of claim 2, wherein the capturing the at least one candidate image from the at least one video stream corresponding to the position information based on the preset capture rule includes:
obtaining state information of the acquisition device; and
capturing, based on the state information and the preset capture rule, the at least one candidate image from the at least one video stream corresponding to the position information.

6. The method of claim 5, wherein the state information includes at least one of a motion speed of the acquisition device, time information associated with the acquisition device, or environment information associated with the acquisition device.

7. The method of claim 5, wherein
the state information includes a motion speed of the acquisition device; and
the capturing, based on the state information and the preset capture rule, the at least one candidate image from the at least one video stream corresponding to the position information includes:
determining whether the motion speed of the acquisition device is less than a first predetermined threshold; and
in response to a determination that the motion speed is less than the first predetermined threshold, capturing, under a first capture mode, the at least one candidate image from at least one video stream corresponding to the position information based on the preset capture rule.

8. The method of claim 7, further comprising:
in response to a determination that the motion speed is larger than or equal to the first predetermined threshold and less than a second predetermined threshold, capturing, under an intermediate capture mode, the at least one candidate image from the at least one video stream corresponding to the position information based on the preset capture rule.

9. The method of claim 8, further comprising:
in response to a determination that the motion speed is larger than the second predetermined threshold, capturing, under a second capture mode, the at least one candidate image from the at least one video stream corresponding to the position information based on the preset capture rule.

10. The method of claim 1, wherein the database is established by a process including:
for each of the plurality of candidate identifications,
obtaining position information of an acquisition device;
determining whether the position information satisfies a predetermined position condition;
in response to a determination that the position information satisfies the predetermined position condition, obtaining at least one tag corresponding to the at least one candidate image, the at least one tag at least indicating position information of the at least one candidate image in at least one video stream corresponding to the position information of the acquisition device; and
generating the candidate identification corresponding to the at least one candidate image based at least in part on the at least one tag.

11. A method for image capturing, comprising:
obtaining position information of an acquisition device;
determining whether the position information satisfies a predetermined position condition;
in response to a determination that the position information satisfies the predetermined position condition, capturing at least one candidate image from at least one video stream corresponding to the position information based on a preset capture rule; and
generating an identification corresponding to the at least one candidate image based at least in part on the position information.

12. A system for image retrieval, comprising:
at least one storage device including a set of instructions; and
at least one processor configured to communicate with the at least one storage device, wherein when executing the set of instructions, the at least one processor is configured to direct the system to perform operations including:
obtaining an image retrieval request from a user device;
identifying at least one target identification matching the image retrieval request from a plurality of candidate identifications in a database, each of the plurality of candidate identifications corresponding to at least one candidate image and at least indicating position information associated with the at least one candidate image; and
obtaining, based on the at least one target identification, at least one target image corresponding to the image retrieval request.

13. The system of claim 12, wherein the database is established by a process including:
for each of the plurality of candidate identifications,
obtaining position information of an acquisition device;
determining whether the position information satisfies a predetermined position condition;
in response to a determination that the position information satisfies the predetermined position condition, capturing the at least one candidate image from at least one video stream corresponding to the position information based on a preset capture rule; and
generating the candidate identification corresponding to the at least one candidate image based at least in part on the position information.

14. The system of claim 13, wherein the determining whether the position information satisfies the predetermined position condition includes:
determining whether a distance between a position of the acquisition device and a predetermined position is less than a distance threshold; or
determining whether the position of the acquisition device is within a predetermined area.

15. The system of claim 13, wherein the preset capture rule includes at least one of a capture time interval, an image quality, or a count of the at least one candidate image.

16. The system of claim 13, wherein the capturing the at least one candidate image from the at least one video stream corresponding to the position information based on the preset capture rule includes:
obtaining state information of the acquisition device; and
capturing, based on the state information and the preset capture rule, the at least one candidate image from the at least one video stream corresponding to the position information.

17. The system of claim 16, wherein the state information includes at least one of a motion speed of the acquisition device, time information associated with the acquisition device, or environment information associated with the acquisition device.

18. The system of claim 16, wherein
the state information includes a motion speed of the acquisition device; and
the capturing, based on the state information and the preset capture rule, the at least one candidate image from the at least one video stream corresponding to the position information includes:
determining whether the motion speed of the acquisition device is less than a first predetermined threshold; and
in response to a determination that the motion speed is less than the first predetermined threshold, capturing, under a first capture mode, the at least one candidate image from at least one video stream corresponding to the position information based on the preset capture rule.

19. The system of claim 18, wherein the operations further comprising:
in response to a determination that the motion speed is larger than or equal to the first predetermined threshold and less than a second predetermined threshold, capturing, under an intermediate capture mode, the at least one candidate image from the at least one video stream corresponding to the position information based on the preset capture rule.

20. The system of claim 19, wherein the operations further comprising:
in response to a determination that the motion speed is larger than the second predetermined threshold, capturing, under a second capture mode, the at least one candidate image from the at least one video stream corresponding to the position information based on the preset capture rule.

21-23. (canceled)
